(19) United States
(12) Patent Application Publication
(10) Pub. No.: US 2010/0014041 A1
(43) Pub. Date: Jan. 21, 2010

(54) Liquid Crystal Display

(76) Inventors: Won-Sang Park, Yongin-si (KR); Jae-Hyun Kim, Suwon-si (KR); Gee-Bum Kim, Incheon (KR); Ji-Youn Choi, Suwon-si (KR)

Correspondence Address: F. CHAU & ASSOCIATES, LLC, 130 WOODBURY ROAD, WOODBURY, NY, 11797, US

(21) Appl. No.: 12/422,039

(22) Filed: Apr. 10, 2009

(30) Foreign Application Priority Data
Jul. 16, 2008 (KR) 10-2008-0069113
Oct. 7, 2008 (KR) 10-2008-0098038

(51) Int. Cl. G02F 1/1343

(52) U.S. Cl. 349/143

(57) ABSTRACT

A liquid crystal display includes a first substrate. Transparent storage electrodes are on the first substrate. An insulating layer is on the transparent storage electrodes. Pixel electrodes are on the insulating layer, each of the pixel electrodes overlapping a respective transparent storage electrode. A second substrate opposes the first substrate. A common electrode is on the second substrate and includes an opening.

### CROSS-REFERENCE TO RELATED APPLICATIONS

This application claims priority to and the benefit of Korean Patent Application Nos. 10-2008-0069113 and 10-2008-0098038 filed in the Korean Intellectual Property Office on Jul. 16, 2008 and Oct. 7, 2008, the entire contents of which are incorporated herein by reference.

### BACKGROUND OF THE INVENTION

(a) Field of the Invention

The present invention relates to a liquid crystal display.

(b) Description of the Related Art

A liquid crystal display is a type of flat panel display that is used most widely at present. The typical liquid crystal display includes two display panels in which field generating electrodes such as pixel electrodes and a common electrode are formed, and a liquid crystal layer that is interposed therebetween. In a liquid crystal display, an electric field is generated in the liquid crystal layer when voltages are applied to the field generating electrodes. Then, orientation of liquid crystal molecules in the liquid crystal layer is determined according to the generated electric field. The liquid crystal display then displays an image by controlling polarization of incident light according to the orientation of the liquid crystal molecules.

The liquid crystal display further includes switching elements that are connected to pixel electrodes, and signal lines such as gate lines and data lines for applying voltages to the pixel electrodes wherein the switching elements control the application of the voltages.

Among such liquid crystal displays, a vertically aligned mode (VA mode) liquid crystal display, in which major axes of liquid crystal molecules are arranged perpendicularly to a vertical display panel when no electric field is applied, has recently been in the spotlight because of its high contrast ratio and wide standard viewing angle. Here, the standard viewing angle is a viewing angle having a contrast ratio of 1:10, or a luminance inversion limit angle between grays.

However, the VA mode liquid crystal display may have lower side visibility than front visibility. In order to address this issue, a method of dividing one pixel into two subpixels and making voltages of the two subpixels different has been suggested.

Further, because the liquid crystal display is a light receiving display that does not emit light itself, it displays an image by transmitting light emitted from a lamp of a backlight separately provided at the rear side of the liquid crystal display through the liquid crystal layer, or by transmitting natural light, etc. entering from outside through the liquid crystal layer and reflecting it back through the liquid crystal layer. The former type is called a transmissive liquid crystal display, and the latter type is called a reflective liquid crystal display.

Currently, a transflective liquid crystal display that uses a backlight or external light depending on the environment has been developed and is mainly used for small and medium sized displays.

When such a light receiving display is used as a transmissive liquid crystal display, it has a low aperture ratio due to opaque structures such as thin film transistors (TFTs).

### SUMMARY OF THE INVENTION

An exemplary embodiment of the present invention provides a liquid crystal display having a first substrate. Transparent storage electrodes are on the first substrate. An insulating layer is on the transparent storage electrodes. Pixel electrodes are on the insulating layer, each of the pixel electrodes overlapping a respective transparent storage electrode. A second substrate opposes the first substrate. A common electrode is on the second substrate and includes an opening.

A central part of the opening of the common electrode may correspond to a central part of the pixel electrode.

The liquid crystal display may further include a TFT having a drain electrode connected to the pixel electrode, wherein a connection point of the pixel electrode and the drain electrode may correspond to the opening.

The pixel electrode may include a transmissive electrode and a reflective electrode connected to the transmissive electrode, and the TFT may further include a gate electrode under the reflective electrode.

The liquid crystal display may further include a storage electrode line which contacts the transparent storage electrode.

A storage voltage which changes periodically may be applied to the storage electrode line.

The storage electrode line may be between the plurality of pixel electrodes.

The storage electrode line may partially overlap one side of the pixel electrode.

The liquid crystal display may further include connection bridges for connecting the plurality of transparent storage electrodes.

The liquid crystal display may further include connection islands, the plurality of connection islands respectively overlapping and contacting the connection bridges.

The liquid crystal display may further include a storage electrode line which contacts the transparent storage electrode, wherein the storage electrode line may be within an outer boundary of the transparent storage electrode and the connection bridge.

A storage voltage which changes periodically may be applied to the transparent storage electrode.

The transparent storage electrode and the pixel electrode may include indium tin oxide (ITO) or indium zinc oxide (IZO).

The transparent storage electrode and the pixel electrode may have different thicknesses.

The transparent storage electrode and the pixel electrode may have the same thickness.

Another embodiment of the present invention provides a liquid crystal display including a first substrate; first transparent storage electrodes that are transparent and on the first substrate; gate lines on the first substrate; an insulating layer on the first transparent storage electrode and the gate line; data lines on the insulating layer; pairs of first and second TFTs connected to the gate lines and the data lines; pixel electrodes on the insulator film, each of the plurality of pixel electrodes having first and second subpixel electrodes. A second substrate opposes the first substrate. A common electrode is on the second substrate and includes openings, wherein the first subpixel electrode is connected to the first TFT and the second subpixel electrode is connected to the second TFT. Each of the first subpixel electrodes overlaps each of the first transparent storage electrodes.

The opening may have first and second openings corresponding to central parts of the first and second subpixel electrodes, respectively.

The first TFT may have a drain electrode connected to the pixel electrode, and a connection point of the pixel electrode and the drain electrode may correspond to the opening.

The first subpixel electrode may have a transmissive electrode and a reflective electrode connected to the transmissive electrode, and the first TFT may further have a gate electrode under the reflective electrode.

The liquid crystal display may further have a first storage electrode line and contacts the first transparent storage electrode, and a second storage electrode line overlapping the second subpixel electrode.

The liquid crystal display may further include a second transparent storage electrode contacting the second storage electrode line, the second transparent storage electrode overlapping the second subpixel electrode and having an area that is different from an area of the first transparent storage electrode.

A storage voltage which changes periodically may be applied to the first and second storage electrode lines.

The first and second storage electrode lines may have different widths.

The first storage electrode line may have a greater width than the second storage electrode line.

The liquid crystal display may further include a first storage electrode line and contacts the first transparent storage electrode and a second storage electrode line in the same layer as the first storage electrode line, wherein the first and second storage electrode lines are between the plurality of pixel electrodes.

The first storage electrode line may partially overlap a first side of the first subpixel electrode, and the second storage electrode line may partially overlap a second side of the second subpixel electrode which opposes the first side.

The first TFT may have a first drain electrode connected to the first subpixel electrode, the second TFT may have a second drain electrode connected to the second subpixel electrode, a connection point of the first subpixel electrode and the first drain electrode and a connection point of the second subpixel electrode and the second drain electrode correspond to each of the openings, and the first and second drain electrodes may have different sizes.

Each of the first and second drain electrodes may have a wide end portion that is completely included within a region of the opening.

The wide end portion of the first drain electrode or the second drain electrode may have the same shape as the opening.

A ratio of a channel width to a channel length of the first TFT may be different from a ratio of a channel width to a channel length of the second TFT.

A ratio of a channel width to a channel length of the first TFT may be different from a ratio of a channel width to a channel length of the second TFT.

The liquid crystal display may further include a connection bridges that connects the plurality of first transparent storage electrodes.

A storage voltage which changes periodically may be applied to the first transparent storage electrode.

The liquid crystal display may further include connection islands, the connection islands overlapping and contacting the connection bridge.

The liquid crystal display may further include a first storage electrode line and contacts the first transparent storage electrode and a second storage electrode line overlapping the second subpixel electrode, wherein the first storage electrode line may be within an outer boundary of the first transparent storage electrode and the connection bridge.

The liquid crystal display may further include a second transparent storage electrode overlapping the second subpixel electrode, the second transparent storage electrode being in the same layer as the first transparent storage electrode.

The first and second transparent storage electrodes and the pixel electrode may be ITO or IZO.

A ratio of a thickness of the first transparent storage electrode to a thickness of the first subpixel electrode may be different from a ratio of a thickness of the second transparent storage electrode to a thickness of the second subpixel electrode.

The first and second transparent storage electrodes and the pixel electrode may have the same thickness.

### BRIEF DESCRIPTION OF THE DRAWINGS

FIG. 1 is a layout view of a liquid crystal display according to an exemplary embodiment of the present invention.

FIG. 2 is a cross-sectional view of the liquid crystal display of FIG. 1 taken along line II-II.

FIG. 3 is an equivalent circuit diagram of two subpixels of the liquid crystal display shown in FIGS. 1 and 2.

FIGS. 4 to 13 are layout views of a liquid crystal display according to exemplary embodiments of the present invention.

FIG. 14 is a layout view of a liquid crystal display according to an exemplary embodiment of the present invention.

FIG. 15 is a cross-sectional view of a TFT array panel of the liquid crystal display of FIG. 14 taken along line XV-XV.

FIGS. 16 and 17 are layout views of a liquid crystal display according to exemplary embodiments of the present invention.

### DETAILED DESCRIPTION OF THE EMBODIMENTS

In the drawings, the thicknesses of layers, films, panels, regions, etc., may be exaggerated for clarity. Like reference numerals designate like elements throughout the specification. When it is said that any part, such as a layer, film, region, or plate, is positioned on another part, it means the part is directly on the other part or above the other part with at least one intermediate part.

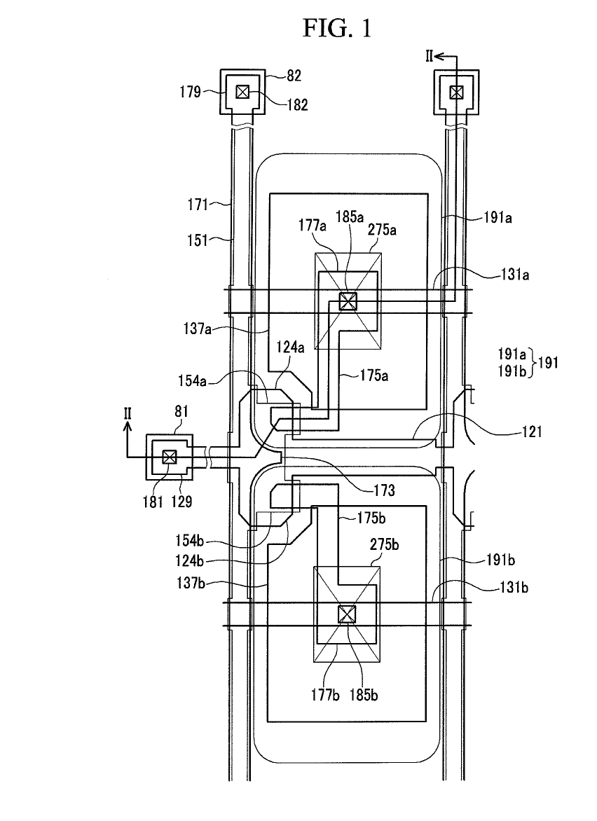

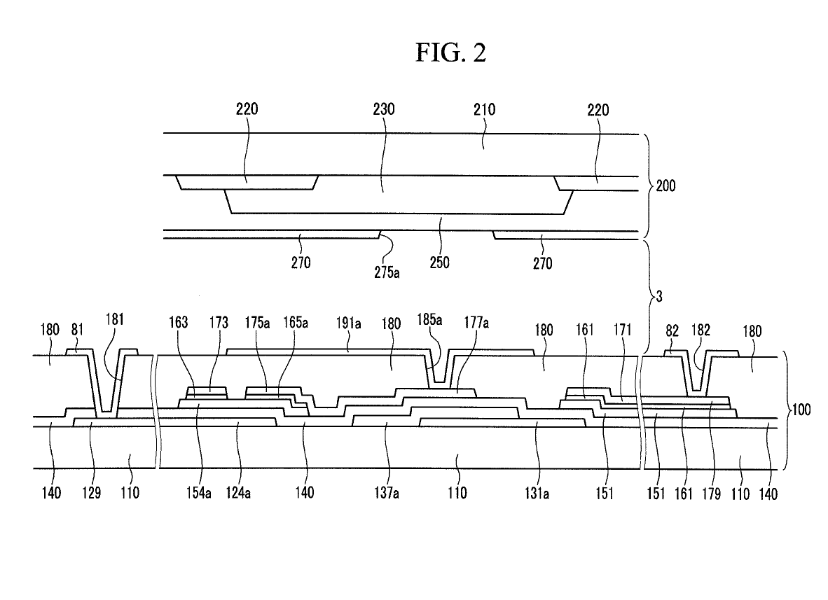

Referring now to FIGS. 1 and 2, the liquid crystal display includes a TFT array panel 100 and a common electrode display panel 200 that are opposite to each other, and a liquid crystal layer 3 that is interposed between the two panels 100 and 200.

Next, the TFT array panel 100 will be described.

Gate lines 121 and pairs of first and second storage electrode lines 131a, 131b are formed on an insulating substrate 110 made of transparent glass, plastic, etc.

The gate lines 121 transfer gate signals and mainly extend in a horizontal direction as depicted in FIG. 1. Each gate line 121 includes a plurality of first and second gate electrodes 124a, 124b (as viewed in FIG. 1 protruding upward and downward), and a wide end portion 129 for connecting to other layers or an external driving circuit.

The first and second storage electrode lines 131a, 131b receive a storage voltage Vst having a periodically changing value, and extend to be almost parallel to the gate lines 121. The first and second storage electrode lines 131a, 131b are at almost the same distance from an upper side and a lower side, respectively, of the gate lines 121.

The first and second storage electrode lines 131a, 131b and the gate lines 121 may be made of an aluminum-based metal such as aluminum (Al) or an aluminum alloy, a silver-based metal such as silver (Ag) or a silver alloy, a copper-based metal such as copper (Cu) or a copper alloy, a molybdenum-based metal such as molybdenum (Mo) or a molybdenum alloy, chromium (Cr), tantalum (Ta), or titanium (Ti). The metals are typically opaque and have low resistance.

First and second storage electrodes 137a, 137b are formed on the first and second storage electrode lines 131a, 131b.

The first and second storage electrodes 137a, 137b have an approximately rectangular shape. As seen in FIG. 1, the first storage electrode 137a is above the gate line 121 and the second storage electrode 137b is below the gate line 121. The first and second storage electrodes 137a, 137b contact with and are connected to the first and second storage electrode lines 131a, 131b, and the first and second storage electrode lines 131a, 131b pass through approximately the center of the first and second storage electrodes 137a, 137b. The first and second storage electrodes 137a, 137b may be made of a transparent conductive material such as amorphous or crystalline ITO or IZO, and the two storage electrodes 137a, 137b may have substantially the same size, as shown in FIG. 1.

The shape and arrangement of the storage electrode lines 131a, 131b and the storage electrodes 137a, 137b may be varied. For example, the vertical position of the storage electrode lines 131a, 131b and the storage electrodes 137a, 137b may be changed.

A gate insulating layer 140 made of silicon nitride (SiNx) or silicon oxide (SiOx), etc. is formed on the substrate 110, the gate lines 121, storage electrode lines 131a, 131b, and the storage electrodes 137a, 137b.

A semiconductor stripe 151 made of hydrogenated amorphous silicon (a-Si), polysilicon, or the like, is formed on the gate insulating layer 140. The semiconductor stripe 151 extends long in a vertical direction and includes first and second protruding portions 154a, 154b that extend above the first and second gate electrodes 124a, 124b.

An ohmic contact stripe 161 and a pair of ohmic contact islands 165a (the remaining one is not shown) are formed on the semiconductor stripe 151. The ohmic contact stripe 161 includes a protruding portion 163 between the first protruding portion 154a and the second protruding portion 154b of the semiconductor stripe 151. The ohmic contacts 161, 165a are made of a material such as n+ hydrogenated amorphous silicon doped with a high concentration of n-type impurities such as phosphorus, or are made of silicide.

A data conductor including data lines 171 and pairs of first and second drain electrodes 175a, 175b is formed on the ohmic contacts 161, 165a and the gate insulating layer 140.

The data lines 171 transfer a data voltage, mainly extend in a vertical direction, and intersect the gate lines 121 and the storage electrode lines 131a, 131b. Each data line 171 includes source electrodes 173 on the protruding portion 163 of the ohmic contact 161 and a wide end portion 179 for connecting to other layers or an external driving circuit.

The first and second drain electrodes 175a, 175b are separated from the data line 171 and are above and below the source electrode 173, respectively.

The first drain electrode 175a has one end on the ohmic contact 165a and has a wide end portion 177a at the center of the first storage electrode 137a, and the second drain electrode 175b has a shape that is symmetrical with the first drain electrode 175a about the gate line 121.

The wide end portion 177a of the first drain electrode 175a and the wide end portion 177b of the second drain electrode 175b may have the same area.

The first and second gate electrodes 124a, 124b, the source electrode 173, and the first and second drain electrodes 175a, 175b together with the first and second protruding portions 154a, 154b of the semiconductor stripe 151 constitute first and second TFTs, and channels of the first and second TFTs are formed in the first and second protruding portions 154a, 154b between the source electrode 173 and the first and second drain electrodes 175a, 175b.

The ohmic contacts 161, 165a exist only between the lower semiconductor stripe 151 and the upper data line 171, and the drain electrodes 175a, 175b, and lower contact resistance therebetween. In the semiconductor stripe 151, there is an exposed portion that is not covered by the data line 171 and the drain electrodes 175a, 175b, and a portion between the source electrode 173 and the drain electrodes 175a, 175b.

A passivation layer 180 is formed on the data line 171, the drain electrodes 175a, 175b, and the exposed portion of the semiconductor stripe 151. The passivation layer 180 is made of an inorganic insulator or an organic insulator and may have a flat surface. The inorganic insulator includes, for example, silicon nitride or silicon oxide. The organic insulator may be photosensitive and preferably has a dielectric constant of about 4.0 or less. However, the passivation layer 180 can have a dual-layer structure of a lower inorganic layer and an upper organic layer in order so as to not damage the exposed portion of the semiconductor stripe 151 while having excellent insulating characteristics.

A contact hole 182 for exposing the end portion 179 of the data line 171 and contact holes 185a, 185b for exposing the wide end portions 177a, 177b of the drain electrodes 175a, 175b are formed in the passivation layer 180. The contact holes 185a, 185b are at the center of the drain electrodes 175a, 175b.

Contact holes 181 for exposing the end portions 129 of the gate lines 121 are formed in the passivation layer 180 and the gate insulating layer 140.

A pixel electrode 191 and auxiliary contact members 81, 82 are formed on the passivation layer 180. They may be made of a transparent conductive material such as ITO or IZO.

The auxiliary contact members 81, 82 are connected to the end portion 129 of the gate line 121 and the end portion 179 of the data line 171 through the contact holes 181, 182, respectively. The auxiliary contact members 81, 82 enhance an adhesive property between the end portion 129 of the gate line 121 and the end portion 179 of the data line 171 and an external device, and protect them.

The pixel electrode 191 includes a first subpixel electrode 191a and a second subpixel electrode 191b that are divided above and below the gate line 121, and each of the subpixel electrodes 191a, 191b is formed in an approximately rectangular shape having rounded corners and occupies most of a region between two adjacent data lines 171.

The first and second subpixel electrodes 191a, 191b are connected to the first and second drain electrodes 175a, 175b of the first and second TFTs through the contact holes 185a, 185b, and receive the same data voltage from the first and second drain electrodes 175a, 175b.

Next, the common electrode display panel 200 will be described.

Light blocking members 220 are formed on an insulating substrate 210 made of transparent glass, plastic, etc. The light blocking member 220 is called a black matrix and prevents light leakage between the pixel electrodes 191.

Color filters 230 are formed on the substrate 210 and the light blocking members 220. The color filters 230 exists mostly within a region defined by the light blocking members 220, and extend in a vertical direction along a long region between two adjacent light blocking members 220. The color filter 230 displays one of the three primary colors of red, green, and blue.

An overcoat 250 is formed on the color filter 230 and the light blocking member 220. The overcoat 250 may be made of an (organic) insulation material, and it prevents the color filter 230 from being exposed and provides a flat surface. The overcoat 250 may be omitted.

A common electrode 270 is formed on the overcoat 250. The common electrode 270 is made of a transparent conductor, such as ITO or IZO, and receives a common voltage.

Pairs of first and second openings 275a, 275b are formed in the common electrode 270. The centers of the first and second openings 275a, 275b approximately coincide with the centers of the contact holes 185a, 185b of the TFT array panel 100, and most wide end portions 177a, 177b of the first and second drain electrodes 175a, 175b may exist within a region of the first and second openings 275a, 275b. The first and second openings 275a, 275b have a different size and similar shape to the first and second subpixel electrodes 191a, 191b, and a predetermined distance or less may be maintained between an edge of the first and second openings 275a, 275b and an edge of the first and second subpixel electrodes 191a, 191b. This is to quicken the recovery of response speed and alignment of liquid crystal molecules of the liquid crystal layer 3 after losing uniformity.

Alignment layers (not shown) are coated on an inner surface of the two display panels 100, 200, and they may be vertical alignment layers.

The liquid crystal layer 3 has negative dielectric anisotropy, and liquid crystal molecules of the liquid crystal layer 3 are aligned so that major axes thereof are substantially perpendicular to surfaces of the two display panels 100, 200 when there is no electric field.

In such a liquid crystal display, the first and second subpixel electrodes 191a, 191b to which a data voltage is applied together with the common electrode 270 of the common electrode display panel 200 generates an electric field that is approximately perpendicular to a surface of the display panels 100, 200 in the liquid crystal layer 3, and a distortion phenomenon of an electric field occurs in a peripheral area of the openings 275a, 275b of the common electrode 270. The liquid crystal molecules of the liquid crystal layer 3 change directions so that the major axes thereof may be perpendicular to an electric field direction in response to the generated electric field, and luminance of light passing through the liquid crystal layer 3 changes according to the determined direction of the liquid crystal molecules. In this case, because the liquid crystal molecules are inclined in various directions by an electric field that is distorted by the openings 275a, 275b of the common electrode, a viewing angle of the liquid crystal display increases and response speed of the liquid crystal molecules is improved.

Further, according to a degree of inclination of the liquid crystal molecules, a change of polarization of incident light and transmittance of the light occurs.

The first and second subpixel electrodes 191a, 191b and the common electrode 270 together with the liquid crystal layer 3 interposed therebetween constitute first and second liquid crystal capacitors, which maintain a voltage between the two electrodes 191a, 191b and common electrode 270.

The first and second subpixel electrodes 191a, 191b and the first and second drain electrodes 175a, 175b constitute first and second storage capacitors by overlapping with the first and second storage electrodes 137a, 137b and the first and second storage electrode lines 131a, 131b, and enhance the voltage storage ability of the first and second liquid crystal capacitors. The first and second storage capacitors may have the same or different capacitance.

Capacitance of the first and second storage capacitors can be determined by adjusting an overlapping area of the first and second subpixel electrodes 191a, 191b, the first and second drain electrodes 175a, 175b, the first and second storage electrodes 137a, 137b, and the first and second storage electrode lines 131a, 131b, and can be determined using a method of adjusting an area of the first and second storage electrodes 137a, 137b, a method of adjusting an area of the end portions 177a, 177b of the drain electrodes 175a, 175b, or a method of adjusting both areas of the storage electrodes 137a, 137b and the end portions 177a, 177b of the drain electrodes 175a, 175b.

In addition, by changing a distance between the first and second subpixel electrodes 191a, 191b and first and second drain electrodes 175a, 175b, and the first and second storage electrodes 137a, 137b, or by changing a dielectric material that is therebetween, capacitance of the first and second storage capacitors may be changed.

Among these methods, because the storage electrodes 137a, 137b are transparent, their area can be freely adjusted regardless of aperture ratio. Thus, a method of adjusting the area of the storage electrodes 137a, 137b has the highest degree of freedom. However, if the end portions 177a, 177b of the drain electrodes 175a, 175b do not escape the openings 275a, 275b of the common electrode 270, the area of the end portions 177a, 177b can also be freely adjusted regardless of aperture ratio.

Several different methods of adjusting capacitance of the first and second storage capacitors will be described in more detail in the following exemplary embodiment.

Operation of the liquid crystal display shown in FIGS. 1 and 2 will now be described with reference to FIGS. 1 to 3.

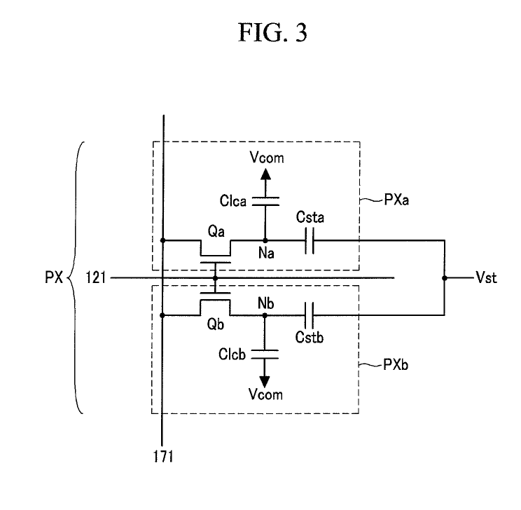

FIG. 3 is an equivalent circuit diagram of two subpixels of the liquid crystal display shown in FIGS. 1 and 2.

The first and second TFTs Qa, Qb, the first and second liquid crystal capacitors Clca, Clcb, and the first and second storage capacitors Csta, Cstb connected to the gate line 121 and the data line 171 constitute first and second subpixels PXa, PXb. The first subpixel PXa and the second subpixel PXb constitute one pixel PX.

If a gate signal applied to the gate line 121 becomes a gate-on voltage Von, the first and second TFTs Qa, Qb are turned on and thus the first and second liquid crystal capacitors Clca, Clcb and the first and second storage capacitors Csta, Cstb are charged with the same data voltage. If the gate signal becomes a gate-off voltage Voff, the first and second TFTs Qa, Qb are turned off and thus the first and second subpixel electrodes 191a, 191b are in a floating state.

In such a state, by changing the magnitude of a storage voltage Vst that is applied to the storage electrode lines 131a, 131b, voltages of the first and second subpixel electrodes 191a, 191b change, and voltage change amounts dVpa, dVpb change according to capacitance Csta, Cstb of the first and second storage capacitors Csta, Cstb, as represented by Equations 1:

$$dVpa = \frac{Csta}{Csta + Clca + Cgda} \times dV , \\ dVpb = \frac{Cstb}{Cstb + Clcb + Cgdb} \times dV \qquad ( Equations 1 )$$

where Clca, Clcb is capacitance of the first and second liquid crystal capacitors Clca, Clcb, Cgda, Cgdb is the parasitic capacitance formed by overlapping of the first and second drain electrodes 175a, 175b and the first and second gate electrodes 124a, 124b, and dV is a change amount of a storage voltage Vst applied to the storage electrode lines 131a, 131b.

If the first storage capacitor Csta and the second storage capacitor Cstb have different capacitances, a voltage change amount dVpa of the first subpixel electrode 191a and a voltage change amount dVpb of the second subpixel electrode 191b are different, whereby the first and second subpixel electrodes 191a, 191b have different voltages and thus luminance represented by the first subpixel PXa and luminance represented by the second subpixel PXb become different. For example, if the capacitance of the first storage capacitor Csta is larger than that of the second storage capacitor Cstb, a voltage of the first subpixel electrode 191a becomes larger than that of the second subpixel electrode 191b. In this way, if the two subpixels PXa, PXb have different luminance, visibility of the liquid crystal display can be improved.

When the first storage capacitor Csta and the second storage capacitor Cstb have the same capacitance, by differently forming a voltage change amount of the first storage electrode line 131a and a voltage change amount of the second storage electrode line 131b or by forming a voltage change amount of the first storage electrode line 131a and a voltage change amount of the second storage electrode line 131b in an opposite direction, the first and second subpixel electrodes 191a, 191b can have different voltages.

There are several methods of giving the two subpixels PXa, PXb different luminance, and these will be described below.

First, a liquid crystal display according to several exemplary embodiments of the present invention that differently form voltages of the first and second subpixel electrodes 191a, 191b according to various methods will now be described with reference to FIGS. 3 to 13.

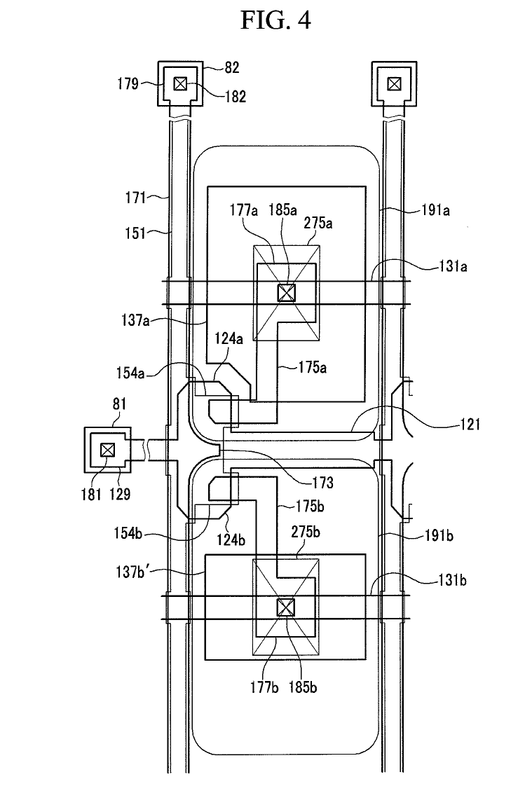

FIGS. 4 to 13 are layout views of a liquid crystal display according to exemplary embodiments of the present invention.

The liquid crystal display shown in FIGS. 4 to 13 has substantially the same sectional structure as the liquid crystal display shown in FIGS. 1 and 2. In the following description of the further exemplary embodiments, elements that are the same as or correspond to elements of the previously described exemplary embodiment are omitted, and like reference numerals designate like elements.

First, referring to FIG. 4, the liquid crystal display shown is similar to the liquid crystal display of FIGS. 1 and 2, but has differently sized first and second storage electrodes 137a, 137b, and thus also has different capacitances of the first and second storage capacitors Csta, Cstb. In FIG. 4, the first storage electrode 137a is larger than the second storage electrode 137b′. In an alternative embodiment the first storage electrode may be smaller than the second storage electrode.

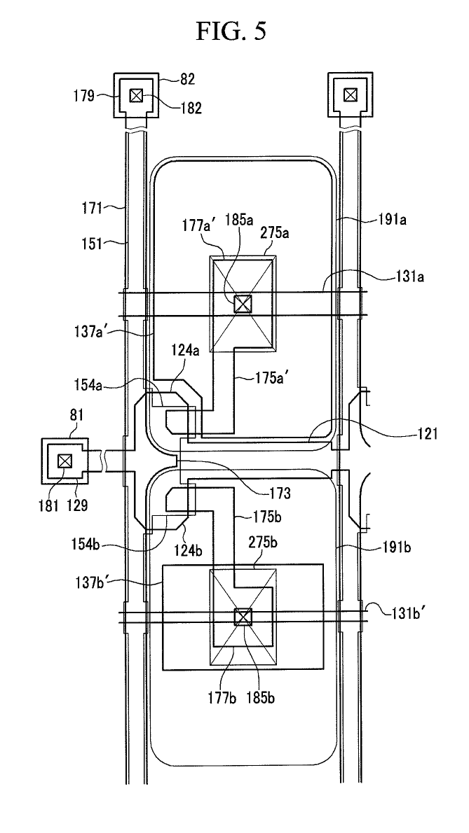

Next, referring to FIG. 5, the liquid crystal display shown is similar to the liquid crystal display of FIG. 4, but the first storage electrode 137a′ is further extended and has almost the same size as the first subpixel electrode 191a, and an overlapping area of the first storage electrode 137a′ and the first subpixel electrode 191a is further widened so that capacitance of the first storage capacitor Csta further increases.

Further, because an area of a wide end portion 177a′ of a first drain electrode 175a′ is larger than that of a wide end portion 177b of the second drain electrode 175b, an overlapping area of the first drain electrode 175a′ and the first storage electrode 137a′ is larger than that of the second drain electrode 175b and the second storage electrode 137b′. In this case, the wide end portion 177a′ of the first drain electrode 175a′ has a longitudinal shape that is similar to a shape of the opening 275a of the common electrode 270, thereby preventing a reduction of aperture ratio.

Further, because a width of the second storage electrode line 131b′ is narrower than that of the first storage electrode line 131a, an overlapping area of the second storage electrode line 131b′, the second subpixel electrode 191b, and the end portion 177b of the second drain electrode 175b is reduced, and thus capacitance of the second storage capacitor Cstb may become less than that of the first storage capacitor Csta.

By adjusting sizes of the first and second storage electrodes, the first and second drain electrodes, or the first and second storage electrode lines, capacitance of the first and second storage capacitors Csta, Cstb can be adjusted. The sizes of the electrodes and the electrode lines, and the capacitance, may be adjusted opposite to the embodiment of FIG. 5.

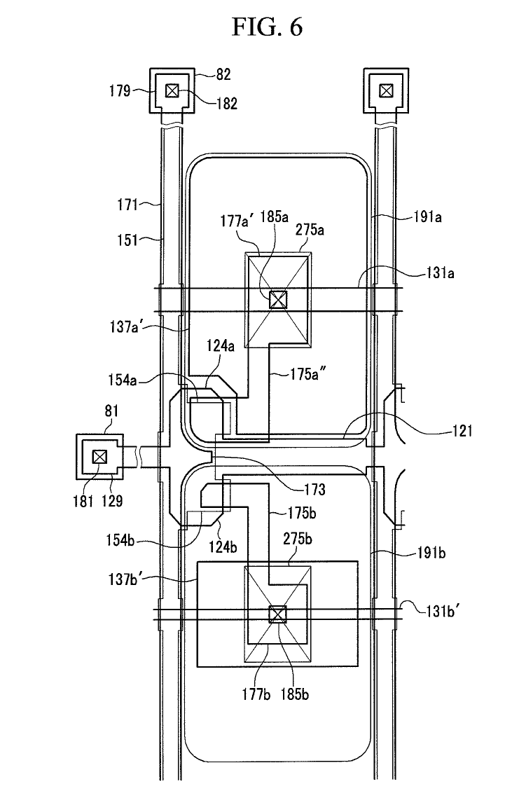

Next, referring to FIG. 6, the liquid crystal display shown is similar to the liquid crystal display of FIG. 5, but the distance between the source electrode 173 and the first drain electrode 175a″ that are opposite to each other, i.e., a channel length L of the first TFT, is smaller than between the source electrode 173 and the second drain electrode 175b. Further, a distance between the opposite source electrode 173 and first drain electrode 175a″, i.e., a channel width W of the first TFT, is longer than a distance between the opposite source electrode 173 and second drain electrode 175b. That is, because ratios W/L of channel widths to channel lengths of the first and second TFTs are different, characteristics of the TFT are also different.

In the present exemplary embodiment, because a ratio W/L of channel width to channel length of the first TFT is larger than that of the second TFT, the current output through the first drain electrode 175a″ is larger than a current output through the second drain electrode 175b, and a voltage applied to the first subpixel electrode 191a is also larger than a voltage applied to the second subpixel electrode 191b.

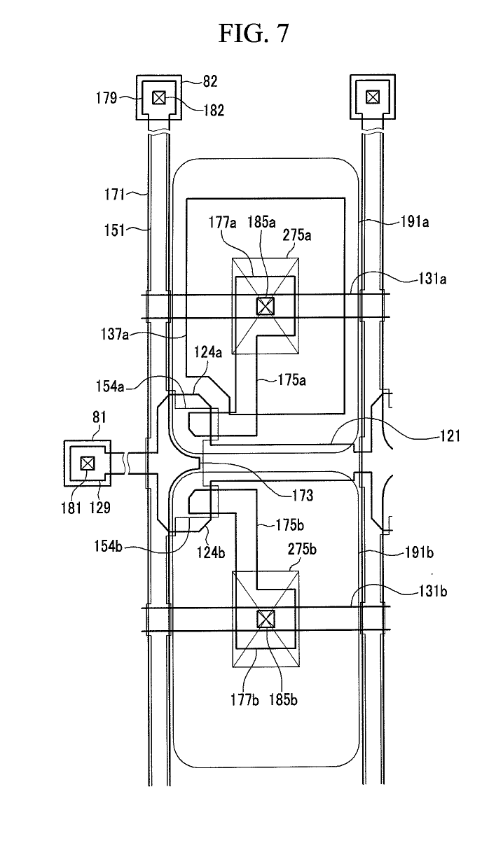

Next, referring to FIG. 7, a liquid crystal display shown is similar to the liquid crystal display of FIG. 4, but includes only the first storage electrode 137a contacting the first storage electrode line 131a and does not include a storage electrode (not shown) contacting the second storage electrode line 131b. Accordingly, because only the second storage electrode line 131b forms the second storage capacitor Cstb by overlapping with the second subpixel electrode 191b and the second drain electrode 175b, the difference in capacitance between the first and second storage capacitors Csta, Cstb can further increase.

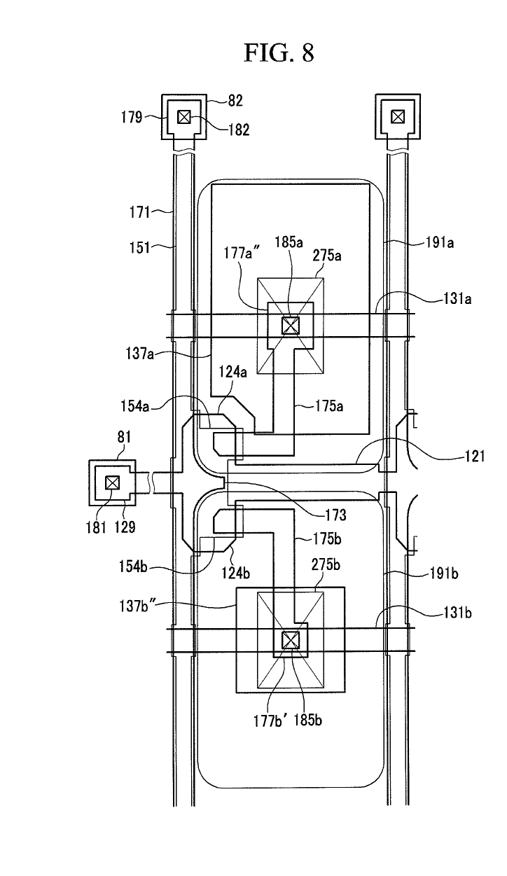

Next, referring to FIG. 8, a liquid crystal display shown is similar to the liquid crystal display of FIG. 4, but the second storage electrode 137b″ of the liquid crystal display according to the present exemplary embodiment is smaller than the second storage electrode 137b′ of the liquid crystal display of FIG. 4, and the wide end portion 177a″ of the first drain electrode 175a has a larger area than the wide end portion 177b′ of the second drain electrode 175b. Therefore, the first storage capacitor Csta has a larger capacitance than the second storage capacitor Cstb.

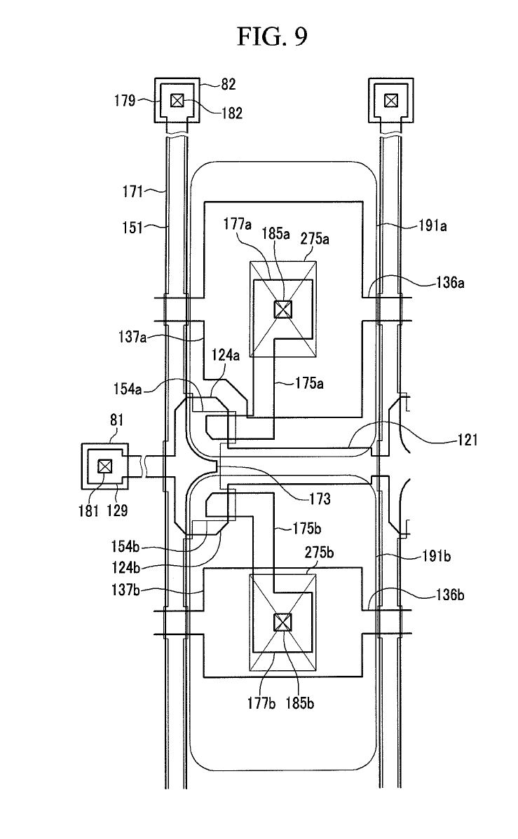

Next, referring to FIG. 9, a liquid crystal display shown is similar to the liquid crystal display of FIG. 4, but it does not have storage electrode lines 131a, 131b. Instead of the storage electrode lines 131a, 131b, connection bridges 136a, 136b for connecting adjacent storage electrodes 137a, 137b are formed on the substrate 110. Unlike the previous exemplary embodiments, in the present exemplary embodiment, because there is no opaque storage electrode line (not shown) for passing through a light transmission region, a reduction of the aperture ratio can be further prevented.

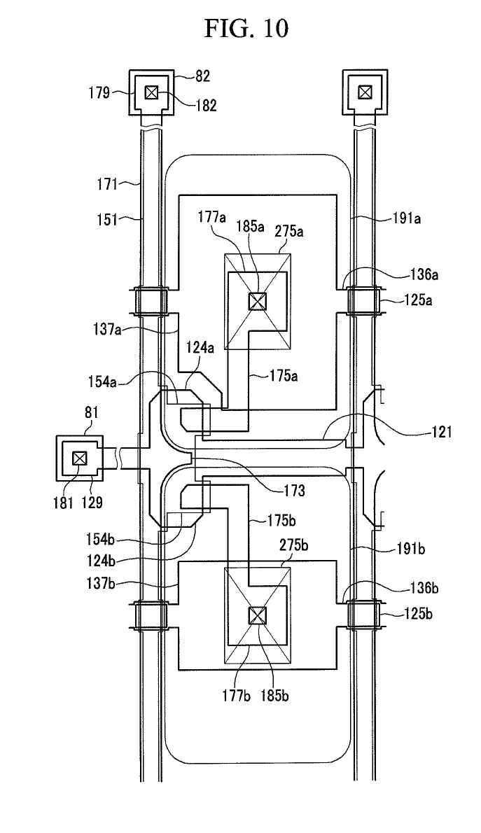

Next, referring to FIG. 10, a liquid crystal display shown is similar to the liquid crystal display of FIG. 9, but in the liquid crystal display according to the present exemplary embodiment, auxiliary connection parts 125a, 125b on or under the connection bridges 136a, 136b and contacting the connection bridges 136a, 136b are formed. The auxiliary connection parts 125a, 125b may be made of the same material as the gate line 121. The auxiliary connection parts 125a, 125b are formed for lowering resistance considering that the connection bridges 136a, 136b having a narrow width are made of ITO or IZO having high resistance, and the storage electrodes 137a, 137b are formed as a surface type.

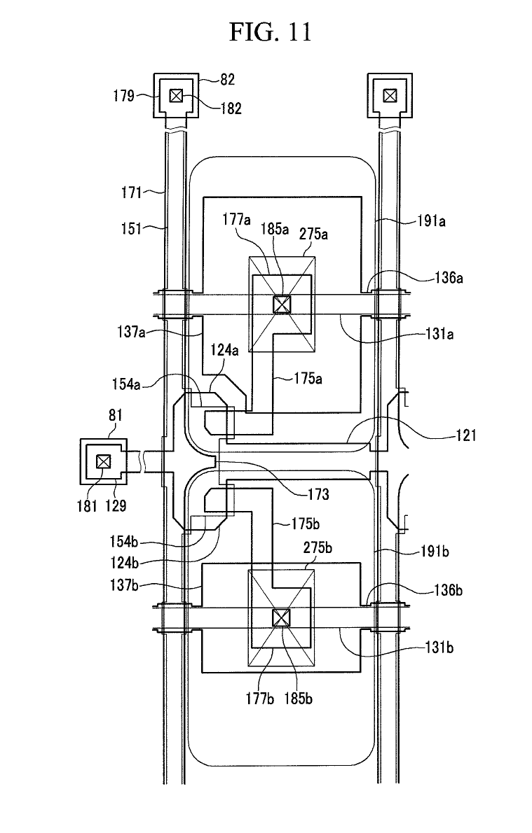

Next, referring to FIG. 11, a liquid crystal display shown is similar to the liquid crystal display of FIG. 9, but the storage electrode lines 131a, 131b are under and completely covered by the storage electrodes 137a, 137b and connection bridges 136a, 136b for connecting them. Thereby, the storage electrode lines 131a, 131b can be protected from external influences such as etching liquid and the like used when forming the storage electrodes 137a, 137b and the connection bridges 136a, 136b by photolithography.

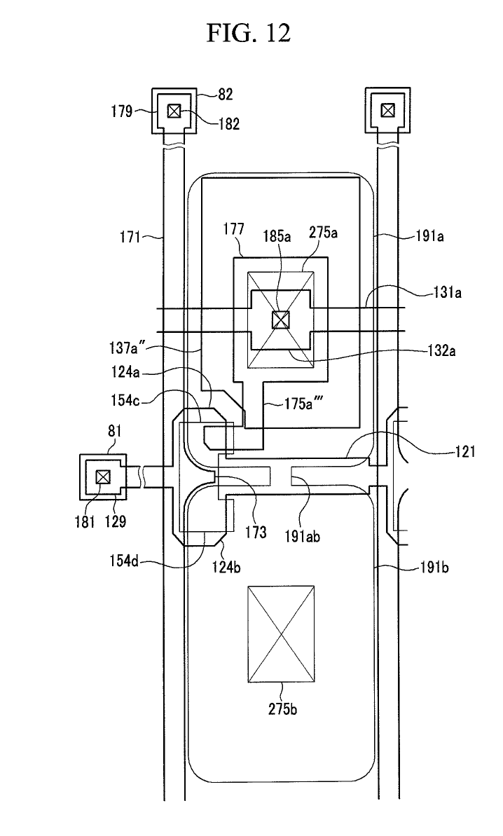

Next, referring to FIG. 12, a liquid crystal display shown is similar to the liquid crystal display of FIG. 7, but in the liquid crystal display according to the present exemplary embodiment, the second storage electrode line 131b and the second drain electrode 175b are omitted and only the first drain electrode 175a′″ that overlaps with the first storage electrode 137a″ is included. Further, the end portion 177 of the first drain electrode 175a′″ is more extended than in the previous exemplary embodiments, and completely overlaps the region of the first opening 275a so that the first opening 275a may be within the outer boundary of the end portion 177 of the first drain electrode 175a′″. Further, the first storage electrode line 131a includes a storage electrode 132a that overlaps the end portion 177 of the first drain electrode 175a′″ and the first opening 275a. Accordingly, the capacitance of the second storage capacitor is further reduced and the capacitance of the first storage capacitor is further increased.

Further, instead of a semiconductor stripe, a plurality of first and second semiconductor islands 154c, 154d are formed on the gate insulating layer 140. Most of the semiconductor islands 154c, 154d are on the first and second gate electrodes 124a, 124b and connected in a vertical direction.

Further, the first subpixel electrode 191a and the second subpixel electrode 191b are connected to each other through a connection part 191ab, and the second subpixel electrode 191b thus receives the same data voltage from the first subpixel electrode 191a instead of a TFT. Unlike other exemplary embodiments, in the present exemplary embodiment, the first and second subpixel electrodes 191a, 191b have the same voltage.

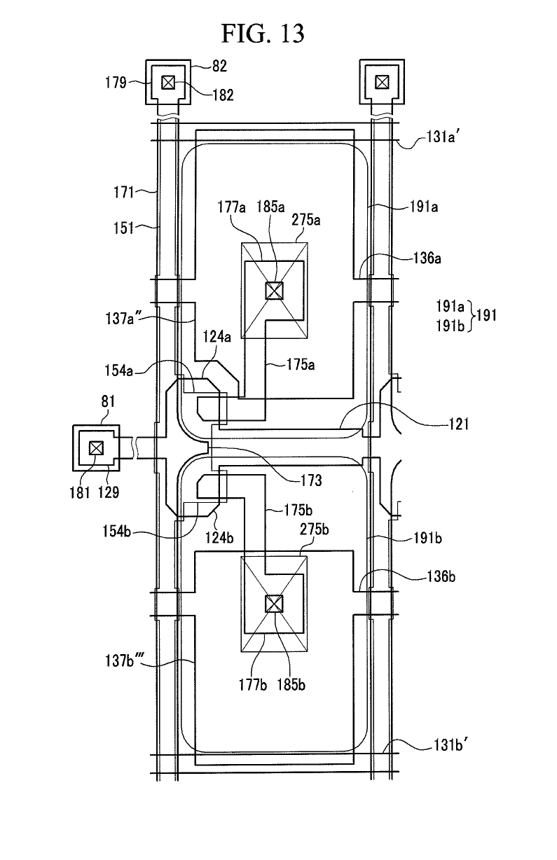

Next, referring to FIG. 13, a liquid crystal display shown is similar to the liquid crystal display of FIG. 9, but further includes first and second storage electrode lines 131a′, 131b′ respectively above and below the first and second subpixel electrodes 191a, 191b. Accordingly, the first and second storage electrodes 137a″, 137b′″ also extend upward and downward and are connected to the first and second storage electrode lines 131a′, 131b′, respectively. Because a storage voltage Vst is transferred by the first and second storage electrode lines 131a′, 131b′ having low resistance, signal delay can be prevented, and because the first and second storage electrode lines 131a′, 131b′ are between the pixel electrodes 191, an aperture ratio can be improved. In an alternative embodiment, the connection bridges 136a, 136b may be omitted.

The operation of the liquid crystal display shown in FIGS. 4 to 13, except for the liquid crystal display of FIG. 12, is similar to the operation of the liquid crystal display of FIGS. 1 to 3.

According to another exemplary embodiment of the present invention, in the liquid crystal display of FIGS. 1 to 13, because the first subpixel electrode 191a is made of crystalline ITO having low resistance and the second subpixel electrode 191b is made of amorphous ITO having relatively high resistance, the two subpixel electrodes 191a, 191b may have different voltages.

In the several exemplary embodiments described above, the first subpixel PXa and the second subpixel PXb may have opposite structures.

Voltages of the first and second subpixel electrodes 191a, 191b can be changed by various other methods in addition to those described above.

In addition, by making the thickness of the first storage electrode or the second storage electrode equal to that of the first subpixel electrode or the second subpixel electrode, or by making the thickness of the first storage electrode or the second storage electrode smaller or larger than that of the first subpixel electrode or the second subpixel electrode, the transmittance of light can be variously adjusted.

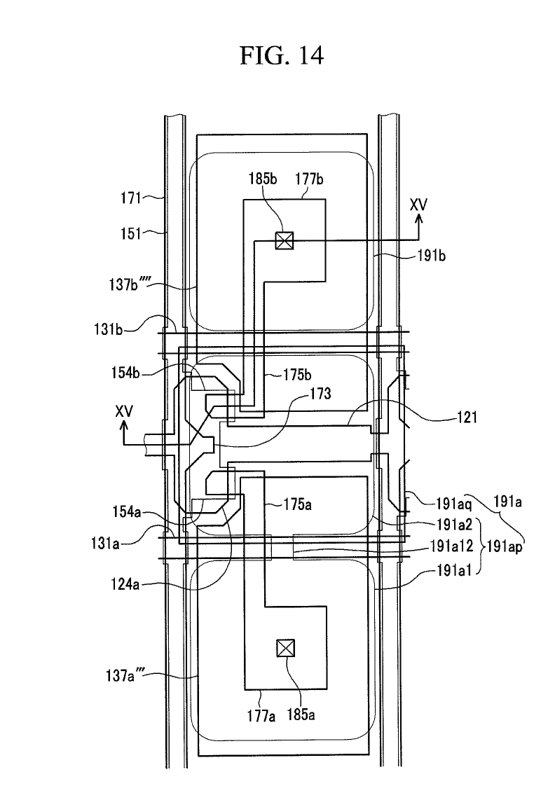

Next, a liquid crystal display according to another exemplary embodiment of the present invention will be described in detail with reference to FIGS. 14 to 17.

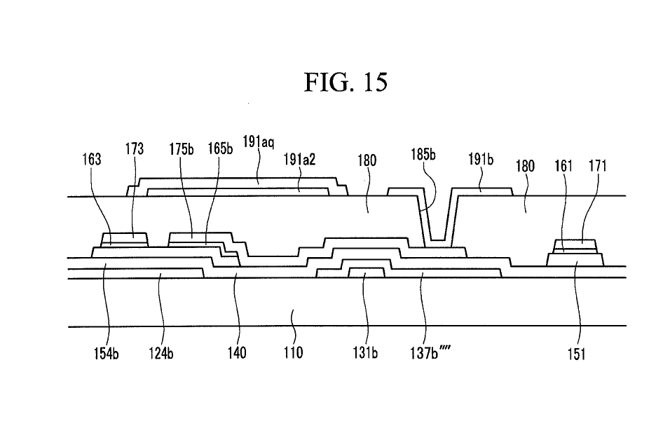

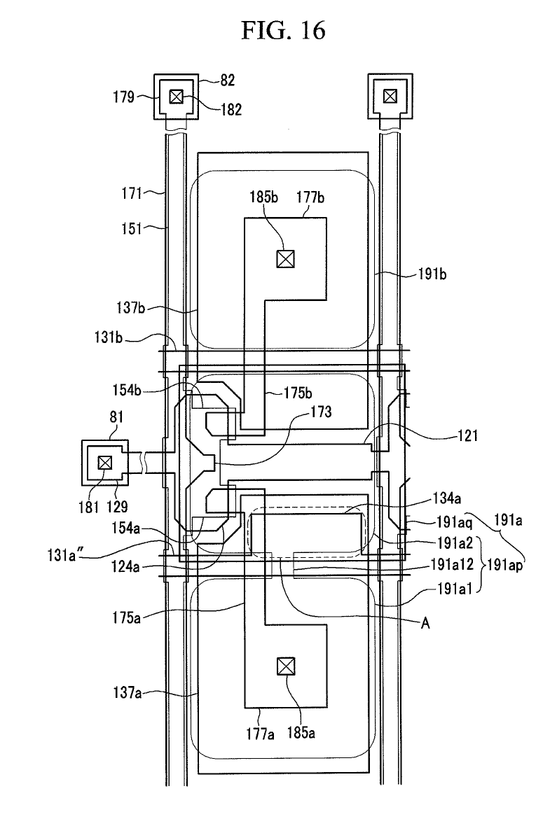

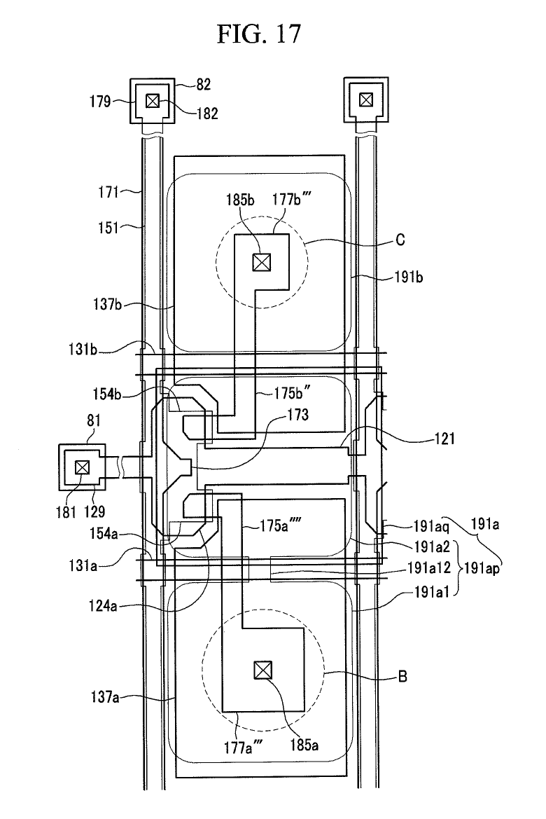

FIG. 14 is a layout view of a liquid crystal display according to another exemplary embodiment of the present invention. FIG. 15 is a cross-sectional view of a TFT array panel of the liquid crystal display of FIG. 14 taken along line XV-XV. FIGS. 16 and 17 are layout views of a liquid crystal display according to several exemplary embodiments of the present invention, and the liquid crystal display shown in FIGS. 16 and 17 also has substantially the same sectional structure as the liquid crystal display of FIGS. 14 and 15.

The liquid crystal display shown in FIGS. 14 to 17 is a transflective liquid crystal display and uses both internal light and external light.

The liquid crystal display according to the present exemplary embodiment has a similar structure to the liquid crystal display shown in FIGS. 1 to 13. That is, the first and second storage electrodes, the first and second storage electrode lines, the gate line, the data line, the semiconductor, the ohmic contacts, the TFTs, the gate insulating layer, the passivation layer, and the contact holes have similar structures.

The end portions 129, 179 of the gate line 121 and the data line 171, the contact holes 181, 182, and the auxiliary contact members 81, 82 shown in FIGS. 1 to 13, except for FIG. 3, are not shown in FIG. 14. This is to show that the end portions 129, 179 of the gate line 121 and the data line 171, the contact holes 181, 182, and the auxiliary contact members 81, 82 are not formed, when a gate driver (not shown) for applying a gate signal to the gate line 121 or a data driver (not shown) for applying a data voltage to the data line 171 is integrated into the TFT array panel 100.

Further, the vertical relationship of the storage electrodes 137a′″, 137b″″ and the storage electrode lines 131a, 131b shown in FIG. 14 is opposite to the relationship shown in FIGS. 1 to 13, showing that this is also optional.

Further, in FIG. 15, the common electrode display panel 200 is not separately shown, indicating that the common electrode display panel 200 of FIG. 14 may be the same as the common electrode display panel 200 of FIGS. 1 to 13.

Characteristics of the present exemplary embodiment are that the first subpixel electrode 191a includes a transmissive electrode 191ap and a reflective electrode 191aq, and the second subpixel electrode 191b is a transmissive type.

Specifically, the pixel electrode 191 includes the first subpixel electrode 191a and the second subpixel electrode 191b, and the first subpixel electrode 191a has an area about two times larger than the second subpixel electrode 191b. The first subpixel electrode 191a includes the transmissive electrode 191ap and the reflective electrode 191aq that contacts thereon.

The transmissive electrode 191ap is connected by a connection part 191a12 and includes two electrode pieces 191a1, 191a2 that have almost the same size. Each of the electrode pieces 191a1, 191a2 has an approximately square shape, and are almost the same size as the second subpixel electrode 191b.

The reflective electrode 191aq is on the electrode pieces 191a1, 191a2 on the TFT among the two electrode pieces 191a1, 191a2, thereby preventing reduction of aperture ratio due to the TFT. The reflective electrode 191aq may be made of a metal having good reflectivity, and a surface thereof may have protrusions and depressions. The protrusions and depressions of the reflective electrode 191aq form protrusions and depressions in a surface of the passivation layer 180, and the protrusions and depressions are transferred to the pixel electrode 191.

The storage electrode lines 131a, 131b pass through a space between the electrode pieces 191a1, 191a2 of the first subpixel electrode 191a, or between the electrode piece 191a2 and the second subpixel electrode 191b, and this is a structure for preventing reduction of aperture ratio. The storage electrode line 131a″ shown in FIG. 16 includes an extension portion 134a that extends upward, as indicated by dotted lines A, and this is to increase capacitance of a storage capacitor. However, because the extension portion 134a is under the reflective electrode 191aq, the aperture ratio is not reduced.

FIG. 17 shows a structure in which storage capacitance is differed by differing an area of the wide end portions 177a′″, 177b′″ of the drain electrodes 175a″″, 175b″, as indicated by dotted lines B, C.

As described above, according to at least one exemplary embodiment of the present invention, the aperture ratio can be improved while improving side visibility of a liquid crystal display.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a first substrate;
transparent storage electrodes on the first substrate;
an insulating layer on the transparent storage electrodes;
pixel electrodes on the insulating layer, each pixel electrode overlapping a respective transparent storage electrode;
a second substrate opposing the first substrate; and
a common electrode on the second substrate, the common electrode having an opening.

2. The liquid crystal display of claim 1, wherein a central part of the opening of the common electrode corresponds to a central portion of a pixel electrode.

3. The liquid crystal display of claim 1, further comprising a thin film transistor comprising a drain electrode connected to the pixel electrode,
wherein a connection point of the pixel electrode and the drain electrode corresponds to the opening.

4. The liquid crystal display of claim 3, wherein the pixel electrode comprises a transmissive electrode and a reflective electrode connected to the transmissive electrode, and
the thin film transistor further comprises a gate electrode under the reflective electrode.

5. The liquid crystal display of claim 1, further comprising a storage electrode line contacting the transparent storage electrode.

6. The liquid crystal display of claim 5, wherein a periodically changing storage voltage is applied to the storage electrode line.

7. The liquid crystal display of claim 5, wherein the storage electrode line is between the pixel electrodes.

8. The liquid crystal display of claim 7, wherein a periodically changing storage voltage is applied to the storage electrode line.

9. The liquid crystal display of claim 7, wherein the storage electrode line partially overlaps one side of the pixel electrode.

10. The liquid crystal display of claim 1, further comprising connection bridges for connecting the transparent storage electrodes.

11. The liquid crystal display of claim 10, further comprising connection islands respectively overlapping and contacting the connection bridges.

12. The liquid crystal display of claim 10, further comprising a storage electrode line contacting the transparent storage electrode,
wherein the storage electrode line is within an outer boundary of the transparent storage electrode and the connection bridge.

13. The liquid crystal display of claim 10, wherein a periodically changing storage voltage is applied to the transparent storage electrode.

14. The liquid crystal display of claim 1, wherein the transparent storage electrode and the pixel electrode comprise indium tin oxide or indium zinc oxide.

15. The liquid crystal display of claim 14, wherein the transparent storage electrode and the pixel electrode have different thicknesses.

16. The liquid crystal display of claim 14, wherein the transparent storage electrode and the pixel electrode have the same thickness.

17. A liquid crystal display comprising:
a first substrate;
transparent first storage electrodes on the first substrate;
gate lines on the first substrate;
an insulating layer on the transparent first storage electrodes and the gate lines;
data lines on the insulating layer;
pairs of a first thin film transistor and a second thin film transistor connected to the gate lines and the data lines;
pixel electrodes on the insulating layer, each of the pixel electrodes comprising a first subpixel electrode and a second subpixel electrode;
a second substrate opposing the first substrate; and
a common electrode on the second substrate, the common electrode having openings,
wherein the first subpixel electrode is connected to the first thin film transistor and the second subpixel electrode is connected to the second thin film transistor, and
each of the first subpixel electrodes overlaps a respective transparent first storage electrode.

18. The liquid crystal display of claim 17, wherein the openings comprise a first opening and a second opening corresponding to central parts of the first subpixel electrode and the second subpixel electrode, respectively.

19. The liquid crystal display of claim 17, wherein:
the first thin film transistor comprises a drain electrode connected to the pixel electrode, and
a connection point of the pixel electrode and the drain electrode corresponds to an opening.

20. The liquid crystal display of claim 19, wherein:
the first subpixel electrode comprises a transmissive electrode and a reflective electrode connected to the transmissive electrode, and
the first thin film transistor further comprises a gate electrode under the reflective electrode.

21. The liquid crystal display of claim 19, further comprising
a first storage electrode line contacting the transparent first storage electrode; and
a second storage electrode line overlapping the second subpixel electrode.

22. The liquid crystal display of claim 21, further comprising a second transparent storage electrode contacting the second storage electrode line, the second transparent storage electrode overlapping the second subpixel electrode and having an area that is different from an area of the first transparent storage electrode.

23. The liquid crystal display of claim 22, wherein a periodically changing storage voltage is applied to the first storage electrode line and to the second storage electrode line.

24. The liquid crystal display of claim 21, wherein the first storage electrode line and the second storage electrode line have different widths.

25. The liquid crystal display of claim 24, wherein the first storage electrode line has a width greater than a width of the second storage electrode line.

26. The liquid crystal display of claim 24, further comprising a second transparent storage electrode contacting the second storage electrode line, the second transparent storage electrode overlapping the second subpixel electrode and having an area that is different from an area of the first transparent storage electrode.

27. The liquid crystal display of claim 26, wherein a periodically changing storage voltage is applied to the first storage electrode line and to the second storage electrode line.

28. The liquid crystal display of claim 17, further comprising a first storage electrode line contacting the first transparent storage electrode, and a second storage electrode line in the same layer as the first storage electrode line,
wherein the first storage electrode line and the second storage electrode line are between the pixel electrodes.

29. The liquid crystal display of claim 28, wherein the first storage electrode line partially overlaps a first side of the first subpixel electrode, and the second storage electrode line partially overlaps a second side of the second subpixel electrode which opposes the first side.

30. The liquid crystal display of claim 28, wherein a periodically changing storage voltage is applied to the first storage electrode line and to the second storage electrode line.

31. The liquid crystal display of claim 17, wherein:
the first thin film transistor comprises a first drain electrode connected to the first subpixel electrode,
the second thin film transistor comprises a second drain electrode connected to the second subpixel electrode,
a connection point of the first subpixel electrode and the first drain electrode and a connection point of the second subpixel electrode and the second drain electrode correspond to each of the openings, and
the first drain electrode and the second drain electrode have different sizes.

32. The liquid crystal display of claim 31, wherein each of the first drain electrode and the second drain electrode comprises a wide end portion that is included within a region of the opening.

33. The liquid crystal display of claim 32, wherein the wide end portion of the first drain electrode or the second drain electrode has the same shape as the opening.

34. The liquid crystal display of claim 31, wherein a ratio of a channel width to a channel length of the first thin film transistor is different from a ratio of a channel width to a channel length of the second thin film transistor.

35. The liquid crystal display of claim 17, wherein a ratio of a channel width to a channel length of the first thin film transistor is different from a ratio of a channel width to a channel length of the second thin film transistor.

36. The liquid crystal display of claim 17, further comprising connection bridges that connect the first transparent storage electrodes.

37. The liquid crystal display of claim 36, wherein a periodically changing storage voltage is applied to the first transparent storage electrode.

38. The liquid crystal display of claim 36, further comprising connection islands overlapping and contacting the connection bridges.

39. The liquid crystal display of claim 36, further comprising:
a first storage electrode line contacting the first transparent storage electrode,
and a second storage electrode line overlapping the second subpixel electrode,
wherein the first storage electrode line is within an outer boundary of the first transparent storage electrode and the connection bridge.

40. The liquid crystal display of claim 39, wherein a periodically changing storage voltage is applied to the first storage electrode line and to the second storage electrode line.

41. The liquid crystal display of claim 17, further comprising a second transparent storage electrode overlapping the second subpixel electrode, the second transparent storage electrode being in the same layer as the first transparent storage electrode.

42. The liquid crystal display of claim 41, wherein the first transparent storage electrodes, the second transparent storage electrodes and the pixel electrodes are of indium tin oxide or indium zinc oxide.

43. The liquid crystal display of claim 42, wherein a ratio of a thickness of the first transparent storage electrode to a thickness of the first subpixel electrode is different from a ratio of a thickness of the second transparent storage electrode to a thickness of the second subpixel electrode.

44. The liquid crystal display of claim 42, wherein the first transparent storage electrodes, the second transparent storage electrodes and the pixel electrodes have the same thickness.
